(19) United States
(12) Patent Application Publication
(10) Pub. No.: US 2026/0314556 A1
(43) Pub. Date: Oct. 15, 2026

(54) PET EXCRETION APPARATUS AND METHOD OF USING SAME

(71) Applicant: Chengdu Petalas Technology Co., Ltd., Chengdu (CN)

(72) Inventors: Qijun ZHU, Chengdu (CN); Zhiyan GAO, Chengdu (CN); Yihan ZHU, Chengdu (CN)

(21) Appl. No.: 19/686,913

(22) Filed: May 25, 2026

Related U.S. Application Data
(63) Continuation of application No. PCT/CN2025/114348, filed on Aug. 13, 2025.

(30) Foreign Application Priority Data
Sep. 10, 2024 (CN) 202411262584.X

(51) Int. Cl. A01K 1/01

(52) U.S. Cl. CPC A01K 1/011

(57) ABSTRACT

A pet excretion apparatus includes a main body, where the main body has a urination and defecation region and an excrement treatment region, and further includes: a waste scraping module, which is movably disposed in the urination and defecation region and configured to push an excrement from the urination and defecation region to the excrement treatment region; a grinding mechanism, which is disposed in the excrement treatment region and configured to break down the excrement in the excrement treatment region; a water supply mechanism, configured to supply water to the urination and defecation region to facilitate cleaning the urination and defecation region, and/or to supply water to the excrement treatment region to facilitate treating the excrement in the excrement treatment region; and a cleaning mechanism, configured to clean the urination and defecation region.

### CROSS REFERENCE TO RELATED APPLICATIONS

This application is a continuation of International Patent Application No. PCT/CN 2025/114348 with a filing date of Aug. 13, 2025, designating the United States, now pending, and further claims priority to Chinese Patent Application No. 202411262584.X with a filing date of Sep. 10, 2024. The content of the aforementioned applications, including any intervening amendments thereto, are incorporated herein by reference.

### TECHNICAL FIELD

The present application relates to the field of pet product manufacturing technology, and in particular to a pet excretion apparatus.

### BACKGROUND

Currently, China's pet industry is developing rapidly. Pet cats, dogs, and the like are increasingly favored by young people who are busy with urban work, and related industries have experienced explosive growth in recent years.

Existing pet toilets such as cat litter boxes generally place water-absorbent cat litter or other auxiliary agglomeration materials in the basin body of the pet toilet. After the excrement from the pet's urination and defecation in the pet toilet forms clumps, it is removed manually or mechanically and set aside. There is no mechanism for treating the excrement or for cleaning the basin body, making it impossible to achieve the purpose of timely cleaning the pet toilet and treating the excrement. As a result, the pet toilet is not cleaned for a long time, and the excrement is left for a long time, which easily breeds bacteria and generates odors. Moreover, manual handling of the excrement causes discomfort and may even affect human health.

### SUMMARY

The present application aims to provide a pet excretion apparatus, so as to at least solve the problems in the existing market of being unable to timely treat pet excrement and clean the pet excretion apparatus.

Another aim of the present application is to provide a method of using the pet excretion apparatus.

To achieve the above aims, the present application provides a pet excretion apparatus, including a main body, where the main body has a urination and defecation region and an excrement treatment region, characterized in that it further includes:
a waste scraping module, which is movably disposed in the urination and defecation region, configured to push excrement from the urination and defecation region to the excrement treatment region;
a grinding mechanism, which is disposed in the excrement treatment region, configured to break down excrement in the excrement treatment region; and,
a cleaning mechanism, configured to clean the urination and defecation region;
a water supply mechanism, configured to supply water to the urination and defecation region to facilitate the cleaning mechanism in cleaning the urination and defecation region, and/or to supply water to the excrement treatment region to facilitate the grinding mechanism in treating excrement.

Preferably, the main body has a moving frame, where the main body and the moving frame are drivingly connected such that the moving frame can move back and forth in the urination and defecation region to approach or move away from the excrement treatment region, and both the waste scraping module and the cleaning mechanism are disposed on the moving frame.

Preferably, the waste scraping module and/or the cleaning mechanism are/is liftably disposed on the moving frame.

Preferably, the main body has a partition between the urination and defecation region and the excrement treatment region, and the main body has a first rail and a second rail. The moving frame has a first connecting portion cooperating with the first rail, and the waste scraping module has a second connecting portion cooperating with the second rail. The moving frame and the waste scraping module are slidably connected so that the waste scraping module can move up and down relative to the moving frame. The first rail and/or the second rail has/have a height transition section, where the distance between the first rail and the second rail gradually changes along the height transition section. When the moving frame or the waste scraping module moves through the height transition section, the waste scraping module slides relative to the moving frame, thereby raising the waste scraping module to a position above the partition.

Preferably, the first rail includes a lead screw disposed on the main body, and the first connecting portion includes a screw nut disposed on the moving frame and cooperating with the lead screw.

Preferably, the second rail includes a circulating rail, and the second connecting portion can move circularly within the circulating rail. The circulating rail includes an upper rail and a lower rail. The upper rail has, at an end of the circulating rail close to the excrement treatment region, an extension rail extending toward the excrement treatment region. When the moving frame moves toward the excrement treatment region, the second connecting portion first moves along the lower rail and then moves into the extension rail, thereby allowing the waste scraping module to cross over the partition and push excrement into the excrement treatment region.

Preferably, the circulating rail has an anti-retraction mechanism, where the anti-retraction mechanism is configured to prevent the waste scraping module from moving back to the lower rail when the waste scraping module moves from the extension rail toward the upper rail.

Preferably, the anti-retraction mechanism includes a blocking piece disposed at a junction between the upper rail and the lower rail near the excrement treatment region, where the second connecting portion can push open the blocking piece only when moving upward from the lower rail.

Preferably, the upper rail includes an upper horizontal rail, and the extension rail is disposed in an extension direction of the upper horizontal rail. The lower rail includes a lower horizontal rail disposed parallel to the upper horizontal rail, a front rail disposed at a front end of the lower horizontal rail and gradually curving toward the upper rail, and a rear rail disposed at a rear end of the lower horizontal rail and connecting the lower horizontal rail with the upper rail.

Preferably, the cleaning mechanism includes a stirring and cleaning mechanism.

Preferably, the cleaning mechanism includes a cleaning motor mounted on the moving frame and fixedly connected to the waste scraping module, and a propeller connected to an output end of the cleaning motor.

Preferably, the waste scraping module includes a connecting frame and a scraper rake disposed at a lower portion of the connecting frame, where the scraper rake gradually inclines from top to bottom toward a side where the excrement treatment region is located.

Preferably, the main body has a urine-permeable filter screen in the urination and defecation region, and the main body has a urine collection tank below the urine-permeable filter screen; and/or the main body has an excrement collection tank in the excrement treatment region, where the excrement collection tank has the grinding mechanism disposed therein.

Preferably, the main body further has a pet urine detection device and/or a pet urine metering device, and the urine collection tank is connected to the pet urine detection device and/or the pet urine metering device via a urine delivery assembly.

Preferably, the main body includes a modular base pan assembly, a side enclosure assembly, and a main unit assembly, where at least two of the base pan assembly, the side enclosure assembly, and the main unit assembly are detachably connected. The base pan assembly, the side enclosure assembly, and the main unit assembly have connection terminals configured to be plugged into circuit portions on other components to form electrical connections.

Preferably, the base pan assembly has the urination and defecation region and the excrement treatment region, the side enclosure assembly has the waste scraping module and the cleaning mechanism, and the main unit assembly has the water supply mechanism and the grinding mechanism.

Preferably, the grinding mechanism includes a grinding motor and a grinding unit, where the grinding unit is mounted on the base pan assembly, the grinding motor is mounted on the main unit assembly, and the transmission shaft is detachably connected to the output end of the grinding motor.

Preferably, the grinding mechanism includes a grinding motor disposed on the main body and a grinding thorn disc drivingly connected to an output end of the grinding motor. The main body or the grinding mechanism has a discharge channel, and the grinding thorn disc is at least partially located in the discharge channel. A circumferential surface of the grinding thorn disc has grinding thorns protruding outward, and/or an upper surface of the grinding thorn disc has grinding thorns protruding upward.

Preferably, the grinding mechanism includes a grinding motor and a grinding unit, and the main body has a grinding unit installation cavity, where the grinding unit is detachably mounted in the grinding unit installation cavity.

Preferably, the grinding unit includes a grinding housing, where a working cavity with an opening on one side is formed inside the grinding housing. A vertically arranged transmission shaft is disposed in the working cavity. An upper end of the transmission shaft is connected to the output end of the grinding motor, and a lower end of the transmission shaft has a grinding thorn disc.

Preferably, an upper end of the transmission shaft is connected to a transmission connecting head, where the transmission connecting head is located at an outer top of the grinding housing, and the transmission shaft is detachably connected to the output end of the grinding motor via the transmission connecting head.

Preferably, the grinding housing has a discharge channel, and the grinding thorn disc is disposed in the discharge channel, where a circumferential surface of the grinding thorn disc, an upper surface of the grinding thorn disc, and/or a lower surface of the grinding thorn disc have/has protruding grinding thorns.

Preferably, a positioning structure is provided between the main body and the grinding unit.

Preferably, the positioning structure includes an anti-rotation positioning structure configured to prevent relative axial rotation between the main body and the grinding unit, and an axial positioning structure configured to axially position the main body and the grinding unit.

Preferably, an inner wall of the discharge channel has grinding thorns protruding inward.

Preferably, the grinding thorns on the discharge channel and the grinding thorns on the circumferential surface of the grinding thorn disc are arranged in a vertically offset manner.

Preferably, it further includes a cleanliness detection device configured to detect a cleanliness level within the urination and defecation region.

Preferably, the cleanliness detection device includes a turbidity detection sensor disposed in the excrement treatment region.

Preferably, water provided by the water supply mechanism flows through the urination and defecation region to the excrement treatment region, and a water passage is provided between the urination and defecation region and the excrement treatment region.

Preferably, a water seal structure is provided in the water passage.

Preferably, the water seal structure includes a water trap portion disposed in the water passage, where the water trap portion, after retaining water, can seal the water passage to block gas flow.

Preferably, a blocking portion extending toward the water trap portion is provided in the water passage at the water trap portion.

Preferably, it further includes a drying mechanism configured to dry the urination and defecation region.

Preferably, the drying mechanism includes a drying fan and an air duct communicating the drying fan with the urination and defecation region.

Preferably, the water supply mechanism includes a water channel, and the water channel and the air duct share a same passage.

Preferably, the air duct extends from the excrement treatment region to the urination and defecation region.

Preferably, it further includes a detergent supply mechanism.

Preferably, the detergent supply mechanism includes an accommodating space provided on the main unit for placing a detergent container or detergent liquid, a liquid level detection mechanism configured to detect a liquid level of the detergent container or detergent liquid, and a pumping mechanism configured to pump the detergent liquid.

Preferably, the main unit has a washing detergent supply module bracket, where the washing detergent supply module bracket has an accommodating space for placing a detergent container or detergent liquid, a liquid level detection mechanism configured to detect a liquid level of the detergent container or detergent liquid, and a pumping mechanism configured to pump the detergent liquid.

Preferably, it further includes a needle piercing structure configured to pierce the detergent container.

Preferably, the main body has a drawer assembly, where the drawer assembly has a pet urine detection device and/or a pet urine metering device.

Preferably, the main body has a urine-permeable filter screen in the urination and defecation region, and the main body has a urine collection tank below the urine-permeable filter screen, where the urine collection tank is connected to the pet urine detection device and/or the pet urine metering device.

Preferably, the pet urine metering device includes a urine metering chamber provided in the main body, a peristaltic pump connecting the urine metering chamber with the urine collection tank, and a liquid level detection device provided in the urine metering chamber.

The present application further relates to a method of using a pet excretion apparatus, including:

Step 1: pushing, by the waste scraping module, excrement from the urination and defecation region to the excrement treatment region;

Step 2: supplying water, by the water supply mechanism, to the urination and defecation region;

Step 3: cleaning, by the cleaning mechanism, the urination and defecation region;

Step 4: supplying water, by the water supply mechanism, to the excrement treatment region, and/or supplying water from the urination and defecation region to the excrement treatment region;

Step 5: breaking down, by the grinding mechanism, excrement in the excrement treatment region;

Step 6: drying, by the drying mechanism, the urination and defecation region.

Preferably, in step 5, the breaking down process involves simultaneously supplying water, breaking down, and flushing away.

Preferably, the urination and defecation region has a washable auxiliary medium for assisting pet excretion, and when the cleaning mechanism cleans the urination and defecation region, it simultaneously cleans the auxiliary medium.

Preferably, the auxiliary medium is washable cat litter.

According to the above content, the beneficial effects of the present application are as follows.

The present application, by providing the waste scraping module, the grinding mechanism, the cleaning mechanism, and the water supply mechanism, can timely treat pet excrement through the waste scraping module, the grinding mechanism, and the water supply mechanism, and can timely clean the urination and defecation region through the cleaning mechanism and the water supply mechanism, thereby achieving the purpose of timely treating pet excrement and cleaning the pet excretion apparatus.

### BRIEF DESCRIPTION OF DRAWINGS

The drawings described herein are intended to provide a further understanding of the present application and constitute a part of the present application. The schematic embodiments and descriptions thereof of the present application are used to explain the present application and do not constitute an undue limitation on the present application.

In the drawings:

FIG. 1 is a overall schematic structural view of the present application.

FIG. 2 is an exploded view of the structure shown in FIG. 1.

FIG. 3 is a first partial exploded structural view of the present application.

FIG. 4 is a second partial exploded structural view of the present application.

FIG. 5 is a schematic view of a rail assembly in the present application.

FIG. 6 is a schematic view of a structure of an anti-retraction mechanism in the present application.

FIG. 7 is a schematic view of the cooperation between a base pan assembly and a grinding unit in the present application.

FIG. 8 is a cross-sectional view of the present application.

FIG. 9 is a schematic view of the structure of a waste scraping module and a cleaning mechanism in the present application.

FIG. 10 is a cross-sectional view of a grinding unit in the present application.

Reference numerals in the drawings: 1: base pan assembly; 2: side enclosure assembly; 3: main unit assembly; 4: connection terminal; 11: urine-permeable filter screen; 12: excrement collection tank; 13: partition; 14: urine collection tank; 21: connecting frame; 211: second connecting portion; 212: scraper rake; 22: cleaning mechanism; 221: cleaning motor; 222: propeller; 23: side supporting wall; 24: moving frame; 241: first connecting portion; 25: first rail; 251: drive motor; 252: transmission rod; 253: bevel gear; 26: second rail; 261: circulating rail; 2611: upper rail; 2612: lower rail; 26121: lower horizontal rail; 26122: front rail; 26123: rear rail; 2613: extension rail; 2614: blocking piece; 31: water supply mechanism; 32: grinding mechanism; 321: grinding motor; 322: grinding housing; 323: working cavity; 324: transmission shaft; 325: transmission connecting head; 326: grinding thorn disc; 3261: grinding thorn; 327: insertion slot; 328: insertion lug; 329: positioning shaft or positioning hole; 33: discharge channel; 41: turbidity detection sensor; 42: water passage; 43: water trap portion; 431: blocking portion; 51: drying fan; 52: air duct; 61: washing detergent supply module bracket; 62: detergent container; 63: liquid level detection mechanism; 64: pumping mechanism; 71: drawer assembly; 72: pet urine detection device; 84: filter mesh; L: height transition section.

### DETAILED DESCRIPTION OF EMBODIMENTS

In order to make the objectives, technical solutions, and advantages of the present application clearer and more comprehensible, the present application is described and illustrated below with reference to the accompanying drawings and embodiments. It should be understood that the specific embodiments described herein are only used to explain the present application and are not intended to limit the present application. Based on the embodiments provided in the present application, all other embodiments obtained by persons of ordinary skill in the art without making creative efforts shall fall within the protection scope of the present application. In addition, it should also be understood that although the efforts made in this development process may be complex and lengthy, for a person of ordinary skill in the art related to the content disclosed in the present application, certain changes in design, manufacture, or production made on the basis of the technical content disclosed in the present application are only routine technical means and should not be understood as insufficient disclosure of the content of the present application.

Reference to “an embodiment” in the present application means that a particular feature, structure, or characteristic described in connection with the embodiment may be included in at least one embodiment of the present application. The appearance of this phrase in various places in the specification does not necessarily refer to the same embodiment, nor is it an independent or alternative embodiment that is mutually exclusive with other embodiments. It is explicitly and implicitly understood by persons of ordinary skill in the art that the embodiments described in the present application may be combined with other embodiments unless inconsistent.

Unless otherwise defined, technical or scientific terms used in the present application shall have the ordinary meaning as understood by a person having ordinary skill in the technical field to which the present application belongs. Words such as “a,” “an,” “one,” “the,” and similar terms used in the present application do not denote a quantity limitation and may mean singular or plural. The terms “including,” “comprising,” “having,” and any variations thereof used in the present application are intended to cover non-exclusive inclusion; for example, a process, method, system, product, or apparatus that includes a series of steps or modules (units) is not limited to the listed steps or units, but may further include unlisted steps or units, or may further include other steps or units inherent to such processes, methods, products, or apparatuses. Words such as “connected,” “coupled,” and similar terms used in the present application are not limited to physical or mechanical connections, but may include electrical connections, whether direct or indirect. “Plurality” as used in the present application means two or greater than two. “And/or” describes the association relationship of associated objects, indicating that three relationships may exist; for example, “A and/or B” may mean: A alone, A and B together, and B alone. Terms such as “first,” “second,” and “third” used in the present application are merely used to distinguish similar objects and do not denote a particular ordering of the objects.

The pet excretion apparatus of the present application includes a main body, where the main body has a urination and defecation region and an excrement treatment region, and further includes:
a waste scraping module, which is movably disposed in the urination and defecation region, configured to push excrement from the urination and defecation region to the excrement treatment region;
a grinding mechanism, which is disposed in the excrement treatment region, configured to break down excrement in the excrement treatment region; and,
a water supply mechanism, configured to supply water to the urination and defecation region to facilitate cleaning the urination and defecation region, and/or to supply water to the excrement treatment region to facilitate treating excrement in the excrement treatment region;
a cleaning mechanism, configured to clean the urination and defecation region;
a detergent supply mechanism, configured to supply detergent to the urination and defecation region;
a drying mechanism, configured to dry the urination and defecation region;

The main body has a urine-permeable filter screen in the urination and defecation region, and the urine-permeable filter screen has a washable auxiliary medium for assisting pet excretion. The main body has a urine collection tank below the urine-permeable filter screen. The main body further has a pet urine detection device and a pet urine metering device, and the urine collection tank is connected to the pet urine detection device and the pet urine metering device via a urine delivery assembly.

The main body has an excrement collection tank in the excrement treatment region, and the grinding mechanism is disposed in the excrement collection tank.

The present application further relates to a method of using the above pet excretion apparatus, including:

Step 1: pushing, by the waste scraping module, excrement from the urination and defecation region to the excrement treatment region;

Step 2: supplying water, by the water supply mechanism, to the urination and defecation region;

Step 3: cleaning, by the cleaning mechanism, the urination and defecation region;

Step 4: supplying water, by the water supply mechanism, to the excrement treatment region, and/or supplying water from the urination and defecation region to the excrement treatment region;

Step 5: breaking down, by the grinding mechanism, excrement in the excrement treatment region;

Step 6: drying, by the drying mechanism, the urination and defecation region.

In step 3, when the cleaning mechanism cleans the urination and defecation region, it simultaneously cleans the auxiliary medium; and in step 5, the breaking down process involves simultaneously supplying water, breaking down, and flushing away.

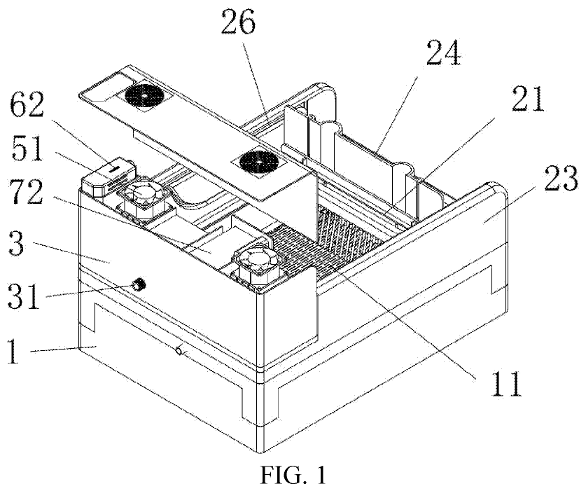

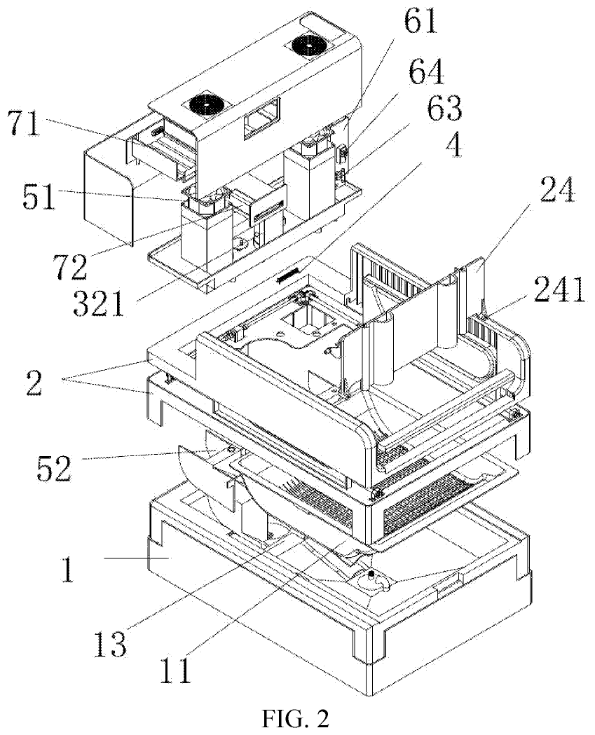

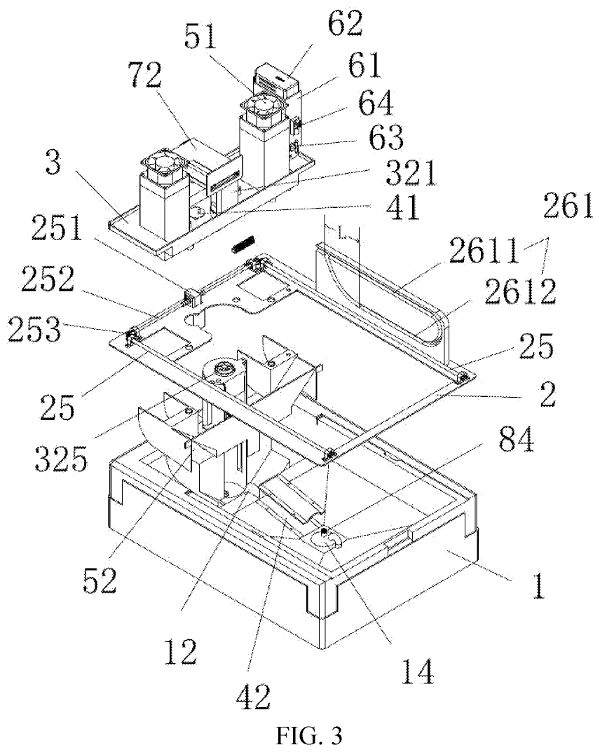

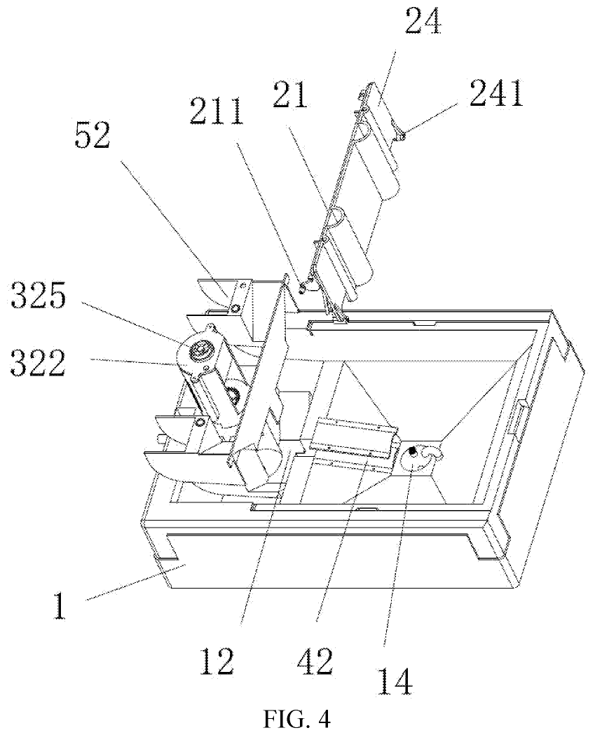

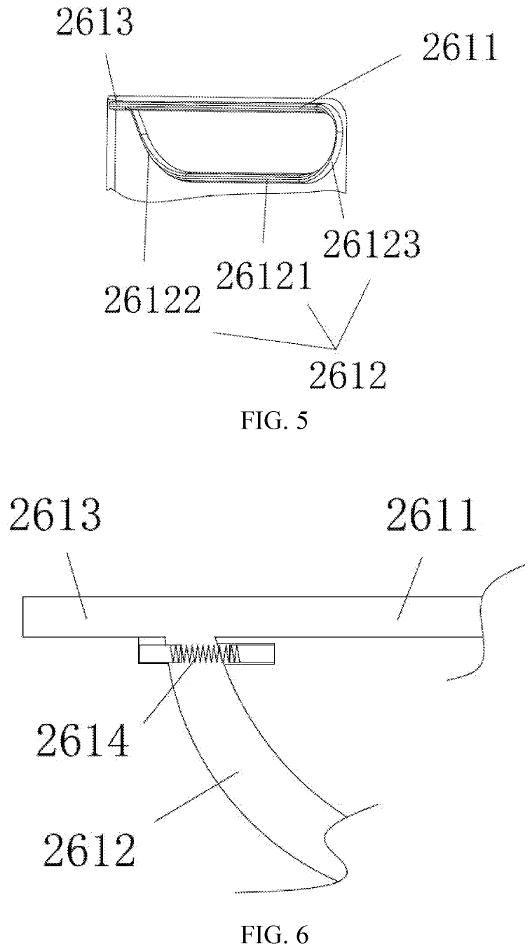

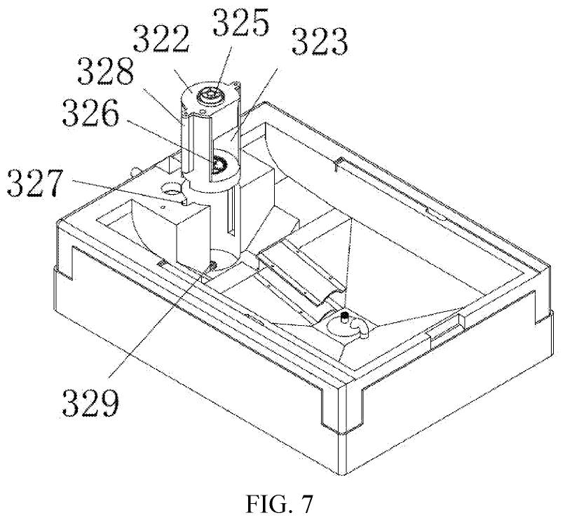

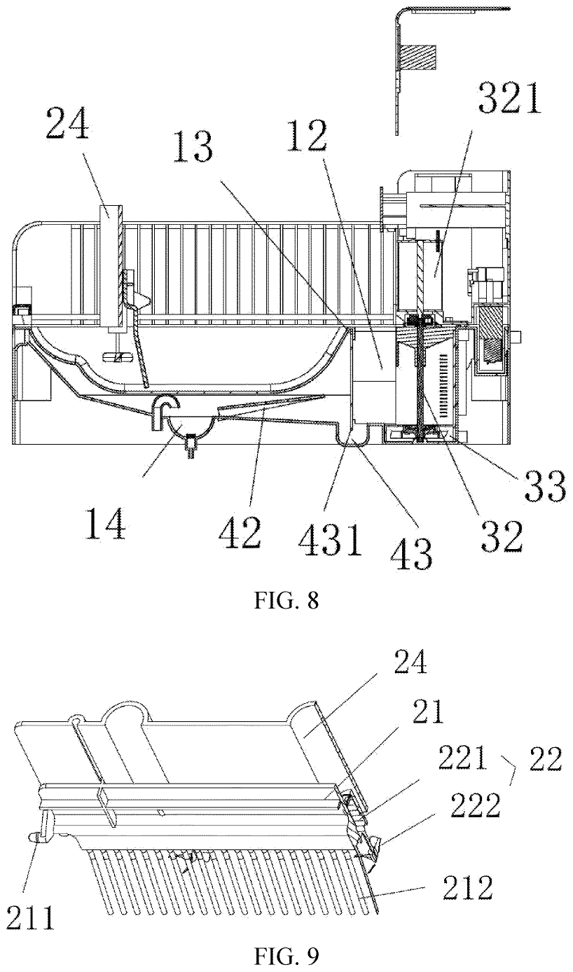

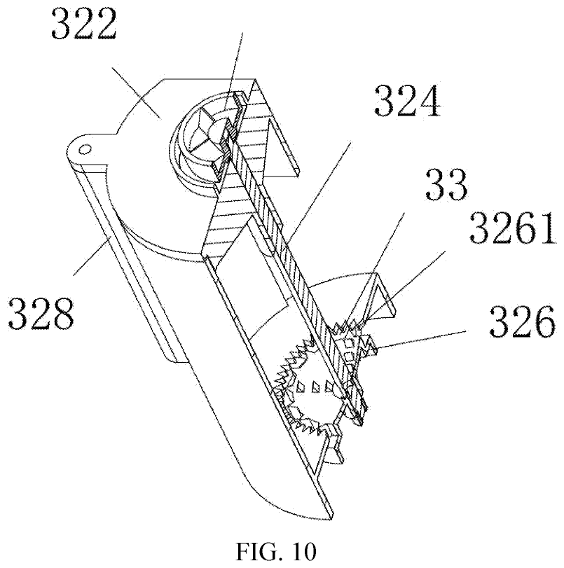

The specific structure of the present application is further described below with reference to FIGS. 1 to 10.

In this embodiment, the pet excretion apparatus is preferably a urination and defecation apparatus suitable for use with a pet cat, where the main body is a basin-shaped structure with a higher front and lower rear composed of a modular base pan assembly 1, a side enclosure assembly 2, and a main unit assembly 3. A detachable connection structure is adopted between two interconnected components among the base pan assembly, the side enclosure assembly, and the main unit assembly. The base pan assembly, the side enclosure assembly, and the main unit assembly are further provided with circuit portions, and the circuit portions are also modularly designed. Connection terminals 4 for connecting the circuit portions are provided on the base pan assembly, the side enclosure assembly, and the main unit assembly, so that after the base pan assembly, the side enclosure assembly, and the main unit assembly are connected, the circuit portion between the base pan assembly and the main unit assembly, and the circuit portion between the side enclosure assembly and the main unit assembly are plugged together via the connection terminals to form electrical connections.

The base pan assembly has a urination and defecation region near the rear end of the main body and an excrement treatment region near the front end of the main body. The main body has a urine-permeable filter screen 11 in the urination and defecation region. The main body has an excrement collection tank 12 in the excrement treatment region. The base pan assembly has a partition 13 between the urination and defecation region and the excrement treatment region. The side enclosure assembly includes two side supporting walls 23, and a waste scraping module and a cleaning mechanism 22 are provided between the two side supporting walls. The main unit assembly has a water supply mechanism 31 and a grinding mechanism 32.

The side enclosure assembly has a moving frame 24 that can move back and forth. The side enclosure assembly and the moving frame are drivingly connected such that the moving frame can move back and forth in the urination and defecation region to approach or move away from the excrement treatment region. The waste scraping module and the cleaning mechanism are fixedly connected and are liftably disposed on the moving frame.

Specifically, the side enclosure assembly of the main body has a rail assembly, which includes a first rail 25 and a second rail 26. The moving frame has a first connecting portion 241 cooperating with the first rail. The waste scraping module has a second connecting portion 211 cooperating with the second rail. The moving frame and the waste scraping module are slidably connected so that the waste scraping module can move up and down relative to the moving frame. A height transition section L is provided between the first rail and the second rail. At the height transition section, the distance between the first rail and the second rail gradually changes. When the moving frame or the waste scraping module moves through the height transition section, the waste scraping module slides relative to the moving frame, thereby raising the waste scraping module to a position above the partition.

In this embodiment, the first rail is a lead screw provided on the side enclosure assembly, and the first connecting portion includes a screw nut provided on the moving frame and cooperating with the lead screw. A drive motor 251 for driving the lead screw to rotate is provided in the side enclosure assembly. Specifically, two sets of lead screws are provided, respectively on the inner sides of the side enclosure assembly near the lower portion. The drive motor is disposed in a housing at the rear end of the side enclosure assembly. The drive motor is a double-shaft motor, with both ends connected via couplings to transmission rods 252. The transmission rods are arranged perpendicular to the lead screws. The ends of the transmission rods and the ends of the lead screws are connected via bevel gears 253 for transmission. When the drive motor operates, it drives the transmission rods to rotate, and the transmission rods drive the lead screws to rotate, thereby driving the moving frame to move back and forth.

The second rail includes a circulating rail 261, and the second connecting portion can move circularly within the circulating rail. The circulating rail includes an upper rail 2611 and a lower rail 2612. The upper rail has, at an end of the circulating rail close to the excrement treatment region, an extension rail 2613 extending toward the excrement treatment region. When the moving frame moves toward the excrement treatment region, the second connecting portion first moves along the lower rail and then moves into the extension rail, thereby allowing the waste scraping module to cross over the partition and push excrement into the excrement treatment region.

The circulating rail has an anti-retraction mechanism, where the anti-retraction mechanism is configured to prevent the waste scraping module from moving back to the lower rail when the waste scraping module moves from the extension rail toward the upper rail.

Referring to FIG. 6, the anti-retraction mechanism includes a blocking piece 2614 disposed at a junction between the upper rail and the lower rail near the excrement treatment region, where the blocking piece is resiliently or gravitationally restorable. The second connecting portion can push open the blocking piece against elastic force or gravity only when moving upward from the lower rail. After the second connecting portion leaves the lower rail, the blocking piece can be restored under elastic force or gravity to block the lower rail again, thereby achieving the anti-retraction purpose.

In this embodiment, the blocking piece may be an elastic blocking rod, for example, the two ends of the blocking rod are rigid rod bodies and the middle is an elastic portion. When the second connecting portion moves upward from the lower rail, it pushes the middle of the blocking rod to elastically deform, thereby pushing the blocking rod away from the junction between the upper rail and the lower rail. After the second connecting portion leaves the lower rail and enters the extension rail, the blocking rod elastically restores to block the lower rail again. At this time, because the lower rail is blocked, the second connecting portion can only travel along the upper rail when exiting the extension rail.

In other embodiments, the blocking piece may also be a rigid blocking rod that is gravity-restorable, with one end hinged to one side of the lower rail and the other end being a free end resting on the other side of the lower rail.

In this embodiment, the upper rail is an upper horizontal rail, and the extension rail is disposed in an extension direction of the upper horizontal rail. The lower rail includes a lower horizontal rail 26121 disposed parallel to the upper horizontal rail, a front rail 26122 disposed at a front end of the lower horizontal rail and gradually curving toward the upper rail, and a rear rail 26123 disposed at a rear end of the lower horizontal rail and connecting the lower horizontal rail with the upper rail in a semi-arcuate shape.

The waste scraping module includes a connecting frame 21 and a scraper rake 212 disposed at a lower portion of the connecting frame, where the scraper rake gradually inclines from top to bottom toward a side where the excrement treatment region is located.

The working process of the waste scraping module is as follows: in an initial state, the moving frame is located on a side close to the excrement treatment region, and the second connecting portion is on the extension rail or the upper rail. At this time, the urination and defecation region forms an open space so that the pet can conveniently enter the urination and defecation region from the rear end. When the pet has excreted in the urination and defecation region and the excrement needs to be transported to the excrement treatment region, the lead screw rotates to drive the moving frame to move toward the rear end. At this time, the second connecting portion moves toward the rear end along the upper rail, and the scraper rake of the waste scraping module remains in a high position to avoid touching the excrement in the urination and defecation region. When the second connecting portion enters the rear rail from the upper rail, the scraper rake of the waste scraping module begins to descend. After the moving frame moves to the rearmost end, the lead screw reverses to drive the moving frame to move toward the front end. At this time, under the constraint of the rear rail, the second connecting portion continues to move downward into the lower horizontal rail, and the scraper rake of the waste scraping module continues to descend. As the moving frame moves forward, the second connecting portion enters the lower horizontal rail and then moves along the lower horizontal rail toward the front rail, and the waste scraping module moves horizontally at this time to push the excrement forward. When the second connecting portion enters the front rail, under the constraint of the front rail, the scraper rake of the waste scraping module begins to rise. When the second connecting portion reaches the upper end of the front rail, it overcomes the resistance of the blocking piece and enters the extension rail, thereby allowing the scraper rake to drive the excrement over the partition member and into the excrement collection area for excrement treatment.

When the lead screw reverses again to drive the moving frame and the waste scraping module to return, because the lower rail is blocked by the blocking piece, the second connecting portion can only move circularly along the upper rail and the lower rail.

After the excrement is pushed into the excrement collection area by the waste scraping module, the urination and defecation region needs to be cleaned by the cleaning mechanism. In this embodiment, the cleaning mechanism adopts a stirring and cleaning mechanism. The stirring and cleaning mechanism includes a cleaning motor 221 mounted on the moving frame and fixedly connected to the connecting frame of the waste scraping module, and a propeller 222 connected to an output end of the cleaning motor.

The grinding mechanism includes a grinding motor 321 and a grinding unit. The grinding motor is mounted on the main unit assembly. The grinding unit is mounted on the base pan assembly. The base pan assembly has a grinding unit installation cavity, and the grinding unit is detachably mounted in the grinding unit installation cavity. The grinding unit includes a grinding housing 322. A working cavity 323 with an opening on one side is formed inside the grinding housing. A vertically arranged transmission shaft 324 is disposed in the working cavity. An upper end of the transmission shaft is connected to a transmission connecting head 325. The transmission connecting head is located at an outer top of the grinding housing. The transmission shaft is detachably connected to the output end of the grinding motor via the transmission connecting head. A lower end of the transmission shaft has a grinding thorn disc 326. The main body or the grinding mechanism has a discharge channel 33. The grinding thorn disc is located in the discharge channel. A circumferential surface of the grinding thorn disc has grinding thorns 3261 protruding outward. An upper surface and a lower surface of the grinding thorn disc have grinding thorns protruding upward. An inner wall of the discharge channel further has grinding thorns protruding inward. Preferably, the grinding thorns on the discharge channel and the grinding thorns on the circumferential surface of the grinding thorn disc are arranged in a vertically offset manner.

After the excrement is pushed into the excrement collection area by the waste scraping module, the grinding mechanism begins to treat the excrement, and the water supply mechanism begins to supply water to the excrement collection area. The water flow flushes the excrement toward the discharge channel. Because the discharge channel is provided with the grinding thorn disc, as the grinding thorn disc rotates, the grinding thorns thereon and the grinding thorns on the inner wall of the discharge channel cooperate with each other to grind the excrement and flush it away through the discharge channel. When the discharge channel is directly connected to a lower water channel, the ground excrement enters the lower water channel.

A positioning structure is provided between the base pan assembly and the grinding unit. The positioning structure includes an anti-rotation positioning structure configured to prevent relative axial rotation between the main body and the grinding unit, and an axial positioning structure configured to axially position the main body and the grinding unit.

Specifically, the anti-rotation positioning structure includes two oppositely disposed insertion slots 327 provided on an inner wall of the grinding unit installation cavity of the base pan assembly, and two insertion lugs 328 provided on a side wall of the grinding housing and correspondingly inserted into the insertion slots. The axial positioning structure includes a positioning shaft or positioning hole 329 provided on a bottom wall of the grinding unit installation cavity, and the grinding housing is provided with a positioning hole or positioning shaft cooperating with the positioning shaft or positioning hole.

The main unit assembly is further provided with a cleanliness detection device configured to detect a cleanliness level within the urination and defecation region.

Specifically, the cleanliness detection device includes a turbidity detection sensor 41 disposed in the excrement treatment region. The main unit assembly has a mounting slot for mounting the turbidity detection sensor. A water passage 42 is provided between the urination and defecation region and the excrement treatment region. Water after cleaning the urination and defecation region enters the excrement treatment region through the water passage, and whether the urination and defecation region is clean is determined by detecting the turbidity of the water in the excrement treatment region.

The drying mechanism includes a drying fan 51 provided on the main unit assembly. The base pan assembly has an air duct 52 communicating with the drying fan and extending from the bottom of the two sides of the excrement treatment region to the urination and defecation region. A water seal structure is provided in the water passage, so that when the urination and defecation region is being dried, drying gas does not enter the excrement treatment region.

In this embodiment, the water seal structure includes a water trap portion 43 disposed in the water passage. After retaining water, the water trap portion submerges and seals the water passage, blocking gas communication between the excrement treatment region and the urination and defecation region, thereby forming the water seal structure. Preferably, a blocking portion 431 extending downward into the water trap portion is provided in the water passage, so that the water passage can be submerged and sealed with less water.

The water supply mechanism includes a pipe joint connected to a tap water pipe and a water channel connected to the pipe joint and extending from the excrement treatment region to the urination and defecation region. In this embodiment, the water channel and the air duct share the same passage.

The detergent supply mechanism includes an accommodating space provided on the main unit for placing a detergent container or detergent liquid, a liquid level detection mechanism configured to detect a liquid level of the detergent container or detergent liquid, and a pumping mechanism configured to pump the detergent liquid.

Specifically, the main unit has a washing detergent supply module bracket 61. The washing detergent supply module bracket has an accommodating space for placing a detergent container 62 or detergent liquid, a liquid level detection mechanism 63 configured to detect a liquid level of the detergent container or detergent liquid, and a pumping mechanism 64 configured to pump the detergent liquid. The pumping mechanism is preferably a peristaltic pump, which can meter the amount of detergent used. The washing detergent supply module bracket is further provided with a needle piercing structure for piercing a bottle cap or sealing film of the detergent container.

The main unit assembly has a pet urine metering device. The main unit assembly has a drawer assembly 71, and the drawer assembly has a retractable pet urine detection device 72.

In this embodiment, washable cat litter is placed above the urine-permeable filter screen as a washable auxiliary medium for assisting pet excretion. Pet urine can permeate through the washable cat litter to below the urine-permeable filter screen to facilitate other operational treatments. The washable cat litter may be selected from washable cat litter having functions such as odor absorption, deodorization, fragrance emission, or bacteriostasis.

The base pan assembly has a urine collection tank 14 below the urine-permeable filter screen. The urine collection tank is connected to the pet urine detection device and/or the pet urine metering device.

The specific structure of the pet urine detection device can be referred to another patent application of the applicant, with patent application number 202421929153X, and will not be described in detail here.

The pet urine metering device may be disposed on the drawer assembly or at other suitable positions of the main body. In this embodiment, the specific structure of the pet urine metering device may be the following structure (not shown in the drawings): including a urine collection tank provided on the base pan assembly, a metering peristaltic pump connected to the urine collection tank via a hose, and a liquid level detection device provided in the hose. The liquid level detection device can detect whether liquid flows through the pipe, thereby counting the time during which liquid flows, and then the amount of urine per urination can be metered based on the unit flow rate of the peristaltic pump.

To prevent the peristaltic pump or the liquid level detection device from being damaged by impurities such as particles in the urine in the urine collection tank, a filter mesh 84 may be provided at the urine outlet of the urine collection tank to filter out impurities in the urine.

The pet excretion apparatus of the present application can easily handle pet urination and defecation. By providing a control circuit board in the main unit assembly, automatic treatment, automatic cleaning, and automatic drying of urine and feces can be achieved, with a high degree of intelligence.

The above-described embodiments merely express several implementation modes of the present application, and their descriptions are relatively specific and detailed, but they should not be construed as limiting the scope of the invention patent. It should be noted that for persons of ordinary skill in the art, several variations and improvements can be made without departing from the concept of the present application, and these fall within the protection scope of the present application. Therefore, the protection scope of the patent of the present application shall be subject to the appended claims.

What is claimed is:

1. A pet excretion apparatus, comprising a main body, the main body comprising a urination and defecation region and an excrement treatment region, and further comprising:
a waste scraping module, movably disposed in the urination and defecation region and configured to push an excrement from the urination and defecation region to the excrement treatment region;
a grinding mechanism, disposed in the excrement treatment region and configured to break down the excrement in the excrement treatment region;
a cleaning mechanism, configured to clean the urination and defecation region; and
a water supply mechanism, configured to: supply water to the urination and defecation region to facilitate the cleaning mechanism cleaning the urination and defecation region, and/or to: supply water to the excrement treatment region to facilitate the grinding mechanism treating excrement.

2. The pet excretion apparatus as recited in claim 1, wherein the main body comprises a moving frame, the main body and the moving frame are drivingly connected such that the moving frame is movable back and forth in the urination and defecation region to approach or move away from the excrement treatment region, and both the waste scraping module and the cleaning mechanism are disposed on the moving frame; wherein the waste scraping module and/or the cleaning mechanism are liftably disposed on the moving frame;
wherein the main body comprises a partition arranged between the urination and defecation region and the excrement treatment region, the main body comprises a first rail and a second rail, the moving frame comprises a first connecting portion cooperating with the first rail, and the waste scraping module comprises a second connecting portion cooperating with the second rail;
wherein the moving frame and the waste scraping module are slidably connected so that the waste scraping module is liftable relative to the moving frame, wherein the first rail and/or the second rail has a height transition section, wherein at the height transition section, a distance between the first rail and the second rail gradually changes along the height transition section, and when the moving frame or the waste scraping module moves through the height transition section, the waste scraping module slides relative to the moving frame thereby raising a position of the waste scraping module to above the partition.

3. The pet excretion apparatus as recited in claim 2, wherein the second rail comprises a circulating rail, and the second connecting portion is movable circularly in the circulating rail;
wherein the circulating rail comprises an upper rail and a lower rail; wherein the upper rail comprises, at an end of the circulating rail adjacent to the excrement treatment region, an extension rail extending toward the excrement treatment region, and when the moving frame moves toward the excrement treatment region, the second connecting portion first moves along the lower rail and then moves into the extension rail thereby allowing the waste scraping module to cross over the partition and push the excrement into the excrement treatment region.

4. The pet excretion apparatus as recited in claim 3, wherein the circulating rail comprises an anti-retraction mechanism, and when the waste scraping module moves from the extension rail toward the upper rail, the anti-retraction mechanism is configured to prevent the waste scraping module from moving back to the lower rail.

5. The pet excretion apparatus as recited in claim 4, wherein the anti-retraction mechanism comprises a blocking piece disposed at a junction between the upper rail and the lower rail adjacent to the excrement treatment region, and wherein the second connecting portion is operative to push open the blocking piece only when moving upward from the lower rail.

6. The pet excretion apparatus as recited in claim 3, wherein the upper rail comprises an upper horizontal rail, the extension rail is disposed in an extension direction of the upper horizontal rail; and
wherein the lower rail comprises a lower horizontal rail disposed parallel to the upper horizontal rail, a front rail disposed at a front end of the lower horizontal rail and gradually curving toward the upper rail, and a rear rail disposed at a rear end of the lower horizontal rail and connecting the lower horizontal rail with the upper rail.

7. The pet excretion apparatus as recited in any one of claims 1 to 6, wherein the main body comprises a moving frame, wherein the main body and the moving frame are drivingly connected such that the moving frame is movable back and forth in the urination and defecation region to approach or move away from the excrement treatment region
wherein the waste scraping module and/or the cleaning mechanism are liftably disposed on the moving frame, wherein the cleaning mechanism comprises a cleaning motor mounted on the moving frame and fixedly connected to the waste scraping module, and a propeller connected to an output end of the cleaning motor; wherein the waste scraping module comprises a connecting frame and a scraper rake disposed at a lower portion of the connecting frame, wherein the scraper rake gradually inclines from top to bottom toward a side where the excrement treatment region is located.

8. The pet excretion apparatus as recited in any one of claims 1 to 6, wherein the main body comprises a urine-permeable filter screen disposed in the urination and defecation region, and the main body comprises a urine collection tank disposed below the urine-permeable filter screen; and/or the main body comprises an excrement collection tank in the excrement treatment region, the excrement collection tank having the grinding mechanism disposed therein;
wherein the main body further comprises a pet urine detection device and/or a pet urine metering device, the urine collection tank being connected to the pet urine detection device and/or the pet urine metering device via a urine delivery assembly.

9. The pet excretion apparatus as recited in any one of claims 1 to 6, wherein the main body comprises a modular base pan assembly, side enclosure assembly, and main unit assembly; wherein at least two selected from the group consisting of the base pan assembly, the side enclosure assembly, and the main unit assembly are detachably connected ;
wherein the base pan assembly, the side enclosure assembly, and the main unit assembly have connection terminals disposed thereon for plugging into circuit portions on other components to form electrical connections;
wherein the base pan assembly comprises the urination and defecation region and the excrement treatment region, the side enclosure assembly comprises the waste scraping module and the cleaning mechanism, the main unit assembly comprises the water supply mechanism and the grinding mechanism;
wherein the grinding mechanism comprises a grinding motor and a grinding unit, the grinding unit is mounted on the base pan assembly, wherein the grinding motor is mounted on the main unit assembly, and the transmission shaft is detachably connected to an output end of the grinding motor.

10. The pet excretion apparatus as recited in any one of claims 1 to 6, wherein the grinding mechanism comprises a grinding motor disposed on the main body and a grinding thorn disc drivingly connected to an output end of the grinding motor, wherein the main body or the grinding mechanism comprises a discharge channel, the grinding thorn disc is at least partially located in the discharge channel;
wherein a circumferential surface of the grinding thorn disc comprises grinding thorns protruding outward, and/or an upper surface of the grinding thorn disc comprises grinding thorns protruding upward.

11. The pet excretion apparatus as recited in any one of claims 1 to 6, wherein the grinding mechanism comprises a grinding motor and a grinding unit, the main body defines a grinding unit installation cavity, the grinding unit being detachably mounted in the grinding unit installation cavity;
wherein the grinding unit comprises a grinding housing, a working cavity with an opening on one side is formed inside the grinding housing, a vertically arranged transmission shaft is disposed in the working cavity, wherein an upper end of the transmission shaft is connected to an output end of the grinding motor, a lower end of the transmission shaft comprises a grinding thorn disc, the grinding housing comprises a discharge channel, the grinding thorn disc being disposed in the discharge channel; and
wherein a circumferential surface of the grinding thorn disc, an upper surface of the grinding thorn disc, and/or a lower surface of the grinding thorn disc comprises/comprise protruding grinding thorns.

12. The pet excretion apparatus as recited in claim 11, wherein a positioning structure is disposed between the main body and the grinding unit;
wherein the positioning structure comprises an anti-rotation positioning structure configured to prevent relative axial rotation between the main body and the grinding unit, and an axial positioning structure configured to axially position the main body and the grinding unit.

13. The pet excretion apparatus as recited in any one of claims 1 to 6, wherein water provided by the water supply mechanism flows through the urination and defecation region to the excrement treatment region, and a water passage is disposed between the urination and defecation region and the excrement treatment region.

14. The pet excretion apparatus as recited in claim 13, wherein a water seal structure is disposed in the water passage.

15. The pet excretion apparatus as recited in claim 14, wherein the water seal structure comprises a water trap portion disposed in the water passage, the water trap portion being configured to seal the water passage to block gas flow after retaining water.

16. The pet excretion apparatus as recited in claim 15, wherein a blocking portion extending toward the water trap portion is disposed in the water passage at the water trap portion.

17. The pet excretion apparatus as recited in any one of claims 1 to 6, further comprising a drying mechanism configured to dry the urination and defecation region, wherein the drying mechanism comprises a drying fan and an air duct communicating the drying fan with the urination and defecation region, the air duct extends from the excrement treatment region to the urination and defecation region, the water supply mechanism comprises a water channel, the water channel and the air duct sharing a same passage.

18. The pet excretion apparatus as recited in any one of claims 1 to 6, further comprising a detergent supply mechanism; the detergent supply mechanism comprises an accommodating space disposed on the main unit for placing a detergent container or detergent liquid, a liquid level detection mechanism configured to detect a liquid level of the detergent container or detergent liquid, and a pumping mechanism configured to pump the detergent liquid;
wherein the main unit comprises a washing detergent supply module bracket, the washing detergent supply module bracket comprising an accommodating space for placing the detergent container or detergent liquid, a liquid level detection mechanism configured to detect a liquid level of the detergent container or detergent liquid, and a pumping mechanism configured to pump the detergent liquid.

19. The pet excretion apparatus as recited in any one of claims 1 to 6, wherein the main body comprises a pet urine detection device and/or a pet urine metering device, the main body comprises a urine-permeable filter screen disposed in the urination and defecation region;
wherein the main body comprises a urine collection tank disposed below the urine-permeable filter screen, and the urine collection tank is connected to the pet urine detection device and/or the pet urine metering device.

20. A method of using a pet excretion apparatus, the pet excretion apparatus comprising a urination and defecation region and an excrement treatment region, the method comprising:
step 1: pushing, by a waste scraping module, an excrement from the urination and defecation region to the excrement treatment region;
step 2: supplying water, by a water supply mechanism, to the urination and defecation region;
step 3: cleaning, by a cleaning mechanism, the urination and defecation region;
step 4: supplying water, by the water supply mechanism, to the excrement treatment region, and/or supplying water from the urination and defecation region to the excrement treatment region;
step 5: breaking down, by a grinding mechanism, the excrement in the excrement treatment region;
step 6: drying, by a drying mechanism, the urination and defecation region;
wherein in step 5, the breaking down process involves simultaneously supplying water, breaking down, and flushing;
wherein he urination and defecation region comprises a washable auxiliary medium for assisting pet excretion, and when cleaning the urination and defecation region, the cleaning mechanism simultaneously cleans the auxiliary medium.
